(19) United States
(12) Patent Application Publication
(10) Pub. No.: US 2007/0050348 A1
(43) Pub. Date: Mar. 1, 2007

(54) Programmatic query assistance

(75) Inventors: Avner Y. Aharoni, Seattle, WA (US); Henricus Johannes Maria Meijer, Mercer Island, WA (US); Brian C. Beckman, Newcastle, WA (US); David N. Schach, Redmond, WA (US); Peter F. Drayton, Redmond, WA (US); Amanda Silver, Seattle, WA (US); Paul A. Vick, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/215,142

(22) Filed: Aug. 30, 2005

(51) Int. Cl. G06F 17/30

(52) U.S. Cl. 707/4

(57) ABSTRACT

The subject disclosure pertains to coding assistance based on context and user preference. Assistance can be provided to facilitate specifying queries and more particularly query comprehension specification. Programmatic support can include but is not limited to providing type information for collections in scope, automatic keyword and/or query clause generation, error identification and tips.

### CROSS-REFERENCE TO RELATED APPLICATIONS

This application is related to U.S. patent application Ser. No. ______, filed Aug. 30, 2005, entitled “QUERY COMPREHENSIONS” [Ref: MS314175.01/MSFTP1121US].

### BACKGROUND

Computer programmers create computer programs by editing source code files and passing these files to a compiler program to create computer instructions executable by a computer or processor-based device. In the early days, this task was most commonly accomplished by using several unrelated command-line utilities. For example, the source code files were written using a text editor program. The source code files were compiled into object code files using a separate compiler program. A linker utility, sometimes a part of the compiler program, combines the object code files into an executable program. Larger software projects may require a build-automation utility to coordinate the compiling and linking stages of the software build. A separate debugger program may be used to locate and understand bugs in the computer program.

An Integrated Development Environment (IDE) is computer software adapted to help computer programmers develop software quickly and efficiently. An IDE provides features to create, modify, compile, deploy, and debug computer programs. An IDE normally consists of a source code editor, a compiler or interpreter, build-automation utilities, and a debugger tightly integrated into a single application environment. Modem IDEs often include a class browser and an object inspector to assist in object-oriented development with a programming language such as C# or Java. Some IDEs also include the capability to interface with a version control system such as CVS or Visual SourceSafe or various tools to facilitate the creation of a graphical user interface (GUI).

An IDE offers a quick and efficient way to develop computer software. Learning a new programming language becomes easier through the use of an IDE since the details of how component parts piece together is handled by the IDE itself. The tight integration enables greater productivity since different steps of the development process can happen concurrently and/or automatically.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure concerns programmatic assistance to facilitate query specification. In one instance, the assistance pertains to coding of query comprehensions. In accordance with an aspect of the innovation, a keyword component is provided that identifies a keyword associated with a query statement. An assistance component, upon notification of the presence of the keyword, can then provide coding assistance for specifying a query clause expression including but not limited to automatic completion and hinting based on context such as all collections in scope.

In accordance with another aspect, valuable assistance can be provided by directing specification of a query. In particular, a user can be directed to enter collection data prior to identifying data to be selected from the collection such that hinting and other assistance can be based on one or more pertinent collections. In one instance, upon entry of a data keyword, a collection keyword can be generated automatically and the cursor positioned after the collection keyword.

Other mechanisms and processes are provided to facilitate query specification in accordance with aspects of the subject innovation. For instance, errors or potential errors in queries can be identified. Additionally or alternatively, tips can be provided upon selection or identification of a query element including but not limited to the type of the element.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates computer programming with respect to query specification.

FIG. 2 is a block diagram of an assistance component.

FIG. 3 is a block diagram of a display component.

FIG. 4 is a block diagram of a display component comprising an intelligence component.

FIG. 5 is a block diagram of an assistance component including an error component.

FIG. 6 is a block diagram of an assistance component that comprises a tip component.

FIG. 7 is a flow chart diagram of query interaction methodology that facilitates query specification.

FIG. 8 is a flow chart diagram of a method of facilitating query specification.

FIG. 9 is a flow chart diagram of a method of aiding query coding.

FIG. 10 is a flow chart diagram depicting the method of facilitating query coding via error indication.

FIG. 11 is a flow chart diagram of a method for aiding query specification utilizing tips.

FIG. 12 is a schematic block diagram of an exemplary compilation environment.

FIG. 13 is a schematic block diagram illustrating a suitable operating environment.

FIG. 14 is a schematic block diagram of a sample-computing environment.

### DETAILED DESCRIPTION

The various aspects of the subject invention are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component” and “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs. Furthermore, various exemplary code snippets are provided herein. It should be appreciated that these examples are provided for purposes of clarity and understanding and are not meant to limit the scope of the disclosed subject matter to the languages, architectures and/or features provided thereby.

As used herein, the term “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

Furthermore, it is to be appreciated that queries and query comprehensions can be specified in a variety of formats. Throughout, this disclosure a consistent format is used. A query statement can include a plurality of clauses including keywords and expressions of zero or more elements. For example, a query comprehension can include a data identification keyword that indicates that the expression that follows defines categories of data to be queried. The data identification keyword can include words such as “Select,” and the like. In addition, a query statement can include a collection clause that includes a collection keyword such as “From” followed by the identification of one or more collections. The query statement can also include a condition clause that specifies query conditions. Accordingly, the condition clause can include a condition keyword including but not limited to “Where” and a specification of one or more conditions. The query statement can include additional and/or different clauses and associated keywords and expressions. It should be appreciated that the query statement syntax utilized throughout is merely one of many possibilities contemplated. Accordingly, the query syntax utilized herein has been chosen to facilitate understanding of aspects of the subject innovation and not to limit the query syntax in any manner.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, jump drive . . . ). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

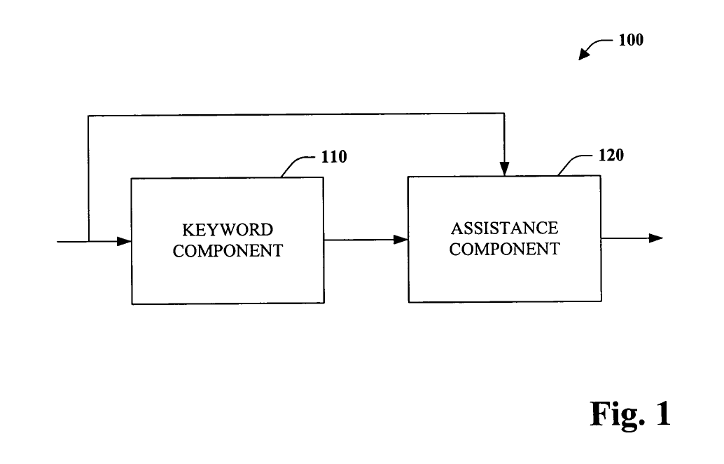

Turning initially to FIG. 1, a system 100 to facilitate computer programming is illustrated. System 100 includes a keyword component 110 and an assistance component 120. Keyword component 110 receives, retrieves, monitors or otherwise obtains or acquires computer code. This code can be specified in an editor as part of an integrated development environment, for example. The keyword component 100 detects query keywords. More specifically, keyword component 110 can identify query comprehension keywords.

A query comprehension is a concise and compositional expression of a query. In particular, query comprehensions are easy to comprehend by understanding each sub-expression in isolation. Compositionality produces a language that is easy to comprehend and ensures that the semantics and typing rules of the language can be defined clearly. In addition, query comprehensions are language or data format agnostic. Hence, queries are separated or independent of a domain. Query comprehensions can be translated into one or more primitive operators, among other things.

Operators such as sequence operators interact with one or more data collections. A data collection can embody a generalized collection or monoid. A collection can be, but is not limited to being, a mathematical collection such as lists (e.g., ordered . . . ), sets, bags and an operational collection including arrays, enumerables, enumerators, cursorables, and cursors. Operators can provide monad operations on collections including but not limited to filtering, mapping, transforming, accumulation, and folding. For example, operators can facilitate filtering by analyzing a collection and throwing out values that do not satisfy a predicate. Additionally or alternatively, operators can perform some transformation on every element or sum all values in a collection. In one particular aspect of the innovation, a fixed set of operators can be employed to provide base or primitive operations on collections. Stated differently, the sequence operators provide the low-level building blocks upon which query comprehensions can be built. A high-level syntax can be utilized to define a query comprehension that translates into one or more query operators. This means that the underlying operators are bound to whatever sequence operators are in scope. This implies that by importing a particular implementation the query syntax can effectively be rebound by a user, for instance. In particular, query comprehensions can be rebound to an operator implementation that attempts to distribute the execution of the query over several data sources.

By way of example and not limitation, a query comprehension can be specified that looks like SQL or has a SQL style format (e.g., Select, From, Where . . . ) and is translated into one or more query operators or expressions including query operators. In this instance, the query would not be restricted to operations on relational data as is the convention. Rather, the query could operate over relational tables, objects, XML (Extensible Mark-up Language) as well as other data formats and/or shapes. The query comprehension is independent of or divorced from a data domain. The query can operate over arbitrary collections.

By contrast, the conventional SQL language and supporting system(s) are very different at least because it is not compositional. Rather, SQL is an ad-hoc design with many special cases. It is not possible to understand a complex SQL query by understanding the individual pieces. One of the reasons that SQL lacks compositionality is that the underlying flat relational data model of SQL is itself not compositional, for instance, all tables must be flat. As a result, instead of breaking up complex expressions into smaller units as described herein, SQL programmers are forced to write a monolithic expression whose result fits in the SQL data model. A more serious negative consequence of the flat relational model is that it does not naturally generalize to deal with other forms of data such as XML and objects.

As mentioned, query comprehensions are based on the notion of monoids and monoid comprehensions. Monoids embody generalized collections and can include (both strongly and late bound) mathematical collections such as lists, sets, bags, operational collections such as arrays, enumerables, enumerators, cursorables, and cursors. Where the type system is fully compositional, there are no restrictions on what types can appear as components of other types. As a result, rows, objects, XML, active directory files, registry entries and the like are all first class citizens.

However, it should be noted that query comprehensions could support special cases and thereby maintain the spirit of such languages as SQL by providing for abbreviations. Abbreviations can make query comprehensions more concise, albeit less compositional. The semantics of such abbreviation can be defined by translation into the fully compositional explicit form.

Assistance component 120 is communicatively coupled to keyword component 110. Furthermore, assistance component 120 can receive code from the keyword component 110 and/or separately there from. Upon identification of a query keyword, keyword component 110 can inform or notify assistance component 120. Assistance component 120 can subsequently provide programmatic assistance related to query specification. As will be discussed in more detail infra, programmatic assistance can include but is not limited to hinting, automatic completion, error identification, and tool tips. Hinting provides type information or properties for example from a drop-down menu for selection by a programmer to remove the onus of learning and recalling all possible elements and syntax that can be inserted at a point in the code. Automatic completion can detect a construct such as a “Select” keyword and automatically insert “From,” “Where” and/or the like to facilitate query specification. The code can also be type checked in the background and errors identified for example by colored squiggly lines. Tool tips enable type information to be provided or bubbled up for a code element or construct on hover by a cursor, for example.

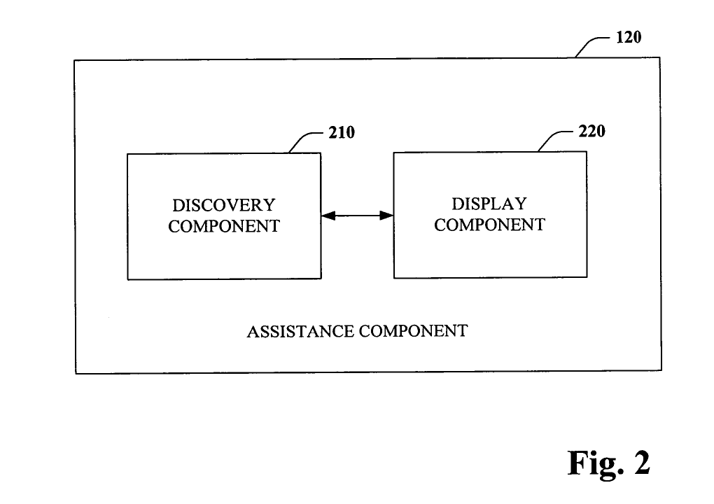

FIG. 2 illustrates an assistance component 220 in accordance with an aspect of the subject disclosure. Assistance component 120 can include a discovery component 210 and a display component 220 communicatively coupled. Discovery component 210 can, among other things, identify types in scope and retrieve type properties or elements, among other things based on context. In one instance, this can be done by employing reflection. These type properties, elements, and the like can be provided to or retrieved by the display component 220. Display component 220 can provide such information to a programmer in an easily comprehensible manner. For example, display component 220 can generate a drop down menu that lists the properties, elements and/or the like for selection. The menu generated by display component 220 can organized the data provided by discovery component 210 in any one of a myriad of different ways. For instance, elements could by listed by type, alphabetically, by likelihood of selection, among others. Furthermore, the menu could be hierarchical and groups of elements can be expandable and collapsible.

To facilitate clarity and understanding the following section provides a few examples of the functionality of assistance component 120. It should be appreciated that these examples are not limiting and other functionality is contemplated and to be considered within the scope of the subject disclosure. The sole purpose of is to provide some examples to aid in the understanding of potential functionality provided by the assistance component 120.

In one instance, upon entry of a data keyword such as “Select” discovery component 210 can determine all appropriate entries based on the collections in scope. The scope of acceptable entries can be reduced based on other entries. For example, if a data collection has been specified, for instance with a data collection keyword such as “From” followed by the collection identification, the collections in scope will be limited by those selected. In particular, when a user enters a “Select” clause, the “From” clause can either already exist as in “Select From C in Customers” or not as in “Select.” In the later case, the discovery component 210 cannot rely on information associated with the “From” clause and would therefore provide display component 220 with information from all the generic collections in scope. After specifying “Select,” when the user enters a space or other trigger, the display component 220 can display a drop down menu showing the properties of all types that are included in all of the generic collections that are in scope, among other things. By contrast, in the former case discovery component 210 would discover type information associated with the “Customers” collection and provide that to display component 220. Display component 220 could then populate a drop down menu with elements, properties, and the like associated with the “Customers” collection alone or among other things, for example, where the relevant items are highlighted.

Furthermore, discovery component 210 can identify and provide display component with query clause specific functions and the like. By way of example and not limitation, the data identification or “Select” clause can include aggregation functions including “Sum” for computing the sum of data items, “Average” for computing the mean of data items, and the like. Discovery component 210 can discover these methods where applicable and provide this information to display component 220. Such methods could then be provided to a user in a drop down menu, for example, thereby relieving a programmer from having to know all the functions that can be employed with particular query clauses.

It should also be appreciated that coding assistance can be provided with respect to query clause expressions and/or sub-expressions. By way of example, if a collection is specified, for instance, in a collection or “From” clause and subsequently an aggregate function or method is selected or typed into a “Select” clause, the assistance should be provided with respect to the aggregate method. In particular, if the collection pertains to employees, and an average method is specified, discovery component 210 could identify the data in the collection that can be averaged, such as salary or bonuses, for presentation by display component 220.

Similar hinting can be provided with respect to other query statement clauses. Clauses specified subsequent to collection identification can take advantage of the information provided thereby. For instance, assistance for all subsequent clauses of the “From” clause in a query can such as but not limited to the “Where” and “Group By” clauses can display information about types in collections that are in scope at that point. In addition, discovery component 210 and display component 220 can cooperate to provide assistance by discovering and hinting with respect to various keywords within query clauses. For example, in the collection or “From” clause, a user can type or otherwise enter the keyword “new” to return a constructed type or “{” to create a row. In the “Select” clause, this can correspond to aggregate functions such as “Count,” “Sum,” or “Average,” as described supra.

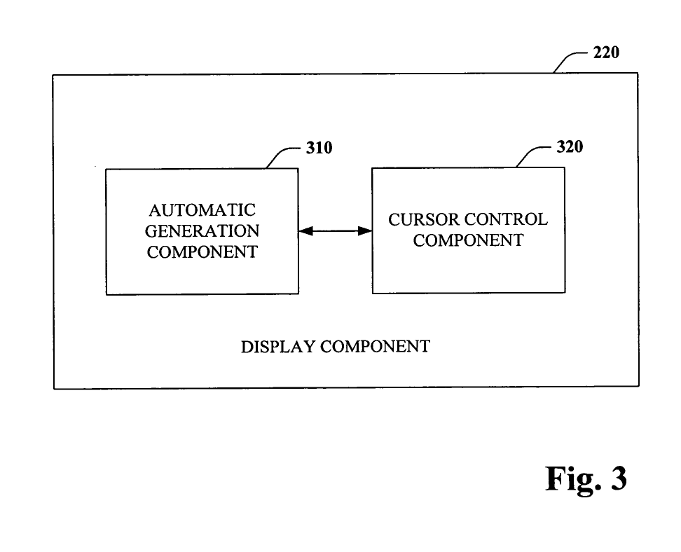

Turning to FIG. 3, a display component 220 is illustrated in accordance with an aspect of the subject disclosure. In addition to presenting data provided by a discovery component 210 (FIG. 2), display component 220 can aid in query statement completion. Display component 220 can include an automatic generation component 310 and a cursor control component 320 communicatively coupled together.

Automatic generation component 310 can generate or produce one or more keywords, among other things. In one instance, these keywords correspond to query statement clauses, functions, and the like. For example, upon notification of receipt of a data keyword such as “Select” (e.g., from keyword component 110 of FIG. 1), keyword generation component 310 can generate a collection keyword such as “From.” Furthermore, upon entry of a collection keyword, a condition keyword such as “Where” can be generated component 310, and the like. Additionally, generation component 310 can automatically complete the clause based on context. For instance, once a user has selected a member from the types included in a generic collection, if the collection is unambiguous based on that property and that type, the collection clause is automatically inserted or updated with the selected collection. By way of example, “Select Name” can expand to “Select Name From Customer” when “Name” uniquely identifies the “Customer” collection.

Cursor control component 320 can direct the information entered and/or otherwise selected. Typically, programmatic assistance such as hinting occurs from left to right and top to bottom. What is specified first can be utilized as context to provide suggestions as to what the user might like to enter next. In particular, with respect to queries, it is often the case where users enter the data items of interest prior to identifying the collection from which those items will be retrieved or filtered. For example, in SQL the “Select” clause is first entered prior to entry of the “From” clause that identifies one or more tables. This creates a situation concerning the presentation of limited and thus useful information to users. To remedy the situation, cursor control component 320 can be used to suggest or indicate that the collection should by specified first. Cursor control component 320 can cooperate with generation component 310 to control query input. For example, upon specification of a data keyword such as “Select” a collection keyword “From” can be automatically generated. Subsequently, the cursor displayed to a user can be positioned in front of the collection keyword to indicate that one or more collections should be specified. Once, the one or more collections are specified the cursor can be moved manually or automatically to other query clauses (e.g., based on a default setting, explicit user preference . . . ) and the collection information can be utilized to limit the scope of assistance. For example, if a “Customer” collection is specified then hinting can pertain to elements, properties, functions, and the like associated with the “Customer” collection alone or such information can be provided first in a list thereby identifying its pertinence, for example.

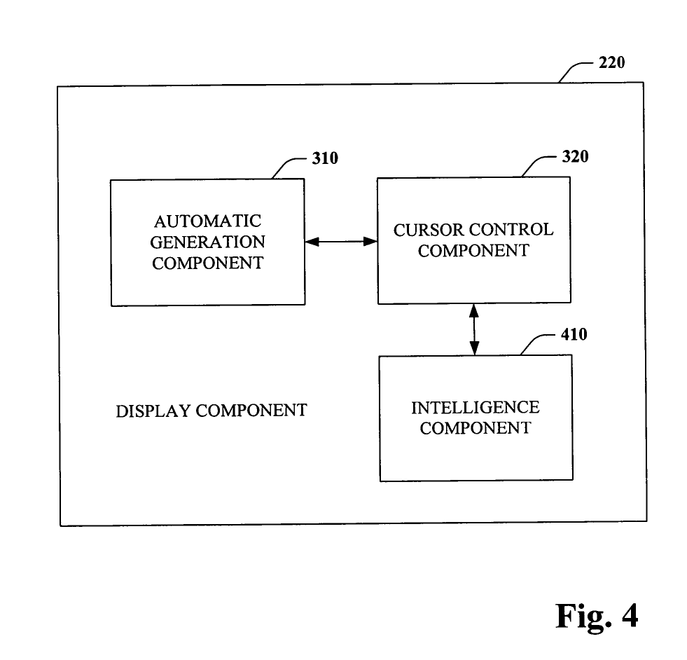

FIG. 4 illustrates display component 220 in accordance with another aspect of the subject innovation. Similar to FIG. 3, display component 220 can include automatic generation component 310 and cursor control component 320. As previously described, generation component 310 can automatically generate keywords associated with a query statement such as “Select,” “From,” “Where,” and “Group By.” Cursor control component 320 can interact or otherwise cooperate with generation component 310 to direct the flow of query input. More specifically, control component can reposition the display cursor after entry of a “Select” keyword to reside in front of a “From” keyword thereby requesting that a user enter identification of one or more collections to be queried first. After specification of one or more collections, the cursor can be repositioned manually by a user or automatically by the cursor control component 320, for example based on an explicit user preference. Cursor component 320 can also be communicatively coupled to an intelligence component 410. Intelligence component 410 can employ knowledge based or artificial intelligence systems and/or methods to learn user preferences. For example, intelligence component 410 can infer through experience that a user prefers to identify data to be selected after entry of one or more collections or that the user desires to identify conditions after selection of a collection, and/or that the user prefers to identify conditions after collection specification and then enter data to be selected or vice versa. The learned sequence preference can be transmitted and received by cursor control component 320. The control component 320 can automatically position the cursor based on learned user preferences.

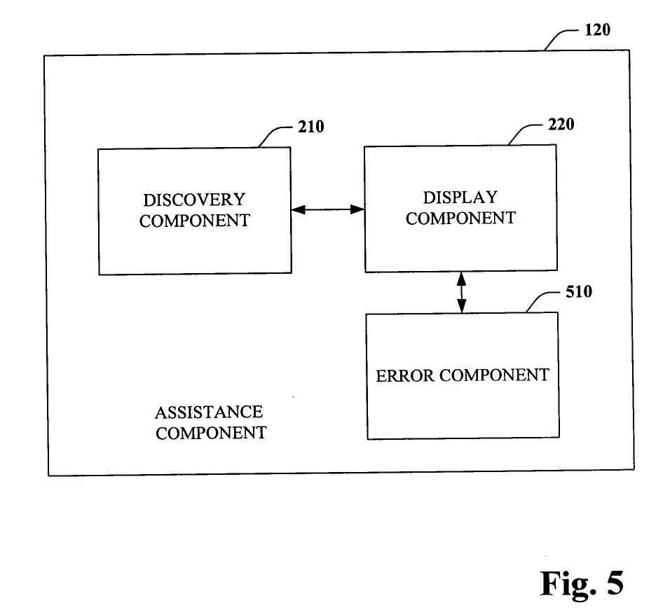

Turing to FIG. 5, an assistance component 120 is illustrated in accordance with an aspect of the subject innovation. Assistance component 120 can include discovery component 210 and display component 220. As described with respect to FIG. 2, discovery component 210 can discover or determine types in scope and retrieve type properties and elements, among other things, based on context. This type information can be communicated to display component 220. Upon receipt, display component 220 can display or present such information to a user for selection, for instance. Assistance component 120 can also include an error component 510 communicatively coupled to display component 220. Error component 510 can analyze code and identify errors or potential errors in query statements, for example based on types. Error information can be passed or retrieved from error detection component 510 and transmitted to display component 220. Display component 220 can then visually identify errors, for instance with squiggly underlines. Furthermore, colors can be employed such that errors are identified in red and potential errors or warnings are provided in blue, for example.

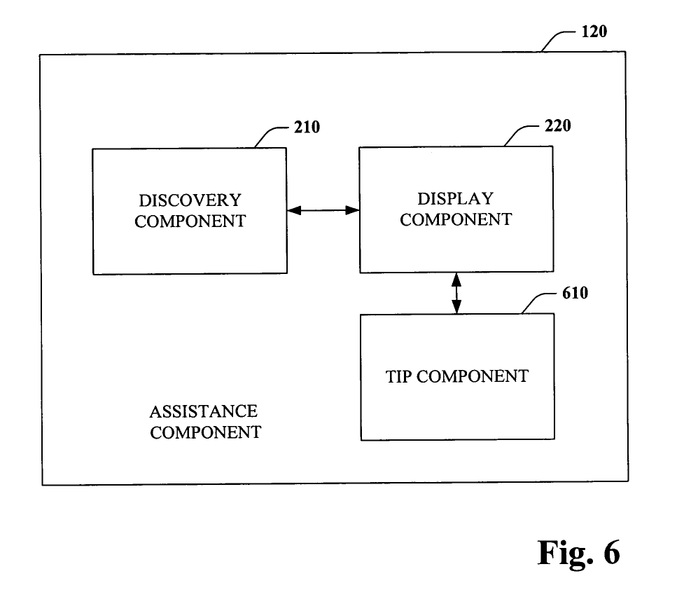

FIG. 6 depicts an assistance component 120 in accordance with another aspect of the subject disclosure. Similar to FIGS. 2 and 5, assistance component 120 can include discovery component 210 and display component 220. Discovery component 210 can discover or identify information concerning queries based on context. This information can be utilized by display component 220 to provide coding assistance to a user. For example, a drop-down menu could be generated and populated with information provided by discovery component 210 in a comprehensible manner. Assistance component 120 can also include a tip component 610 coupled to the display component 220. Tip component 610 can provide, among other things, type information about query elements upon rollover (e.g., by cursor) or depression of a predetermined sequence of keys. This type information can be provided to display component 220 and presented or bubbled up to a user thereby via pop-up of a small box, bubble or window, or display in a status bar, for instance.

The aforementioned systems have been described with respect to interaction between several components. It should be appreciated that such systems and components can include those components or sub-components specified therein, some of the specified components or sub-components, and/or additional components. For example, assistance component 120 can include discovery component 210, display component 220, error component 510, and tip component 610 or a combination thereof. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, intelligence component 410 can employ such methods or mechanism to learn user preferences. As another example, discovery component 210 can employ such methods or mechanisms to infer types based on context and thereby identify pertinent properties, elements, functions and/or the like.

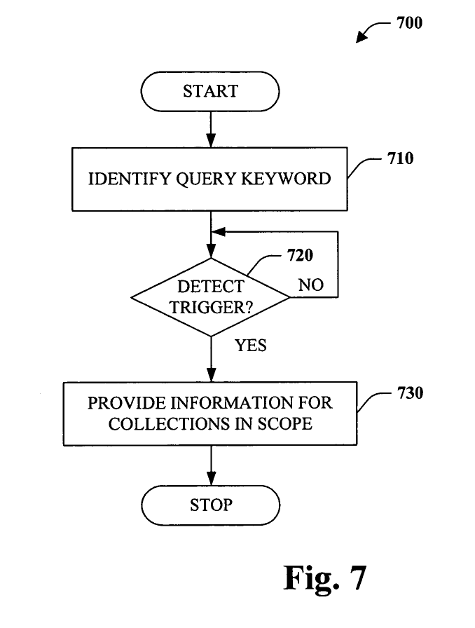

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers or other processor based devices. The term article of manufacture, as used, is intended to encompass a computer program accessible from any computer-readable device, carrier, or media.

Turning to FIG. 7, a query interaction methodology 700 is provided to facilitate query specification. At reference numeral 710, a query keyword is identified. As described supra, a query statement or expression such as a query comprehension can include a plurality of clauses including one or more keywords and an expression comprising zero or more elements. By way of example and not limitation, such keywords can include a data keyword such as “Select” for identifying data to be selected, a collection keyword such as “From” that is followed by one or more collections, a condition keyword like “Where” that precedes a condition expression, and a group keyword such as “Group By” that is followed by an expression concerning how the data should be grouped when returned. A query keyword can also correspond to a keyword within a query clause or expression. For instance, in “Select” clause keywords can correspond to aggregates such as “Sum,” “Count,” and “Average.” In a “From” clause, keywords could correspond to “new” to return a new constructed type or “{” to create a row. At numeral 720, a determination is made as to whether a trigger as been detected. A trigger can correspond, for example, to a space, comma, or new line (using enter key) in relation to particular keywords and/or expressions. For instance, a space may be a trigger following a “Select” keyword such as in “Select” whereas the new line can be a trigger following specification of data in a “Select” clause expression. If a trigger is not detected, the method can loop until one is detected. If a trigger is detected at 720, the method can proceed to 730. At 730, information can be provided for collections in scope, among other things.

By way of example, upon entry of “Select” information regarding all generic collections in scope can be provided and perhaps displayed to a user via an editor and/or IDE. One or more collections can subsequently be identified following a “From” keyword. Next, a condition keyword and/or a particular condition can be entered. Information can be provided to facilitate specification of the one or more conditions. This information can be limited but can also be much more relevant because the collections in scope are limited to those specified in the “From” clause.

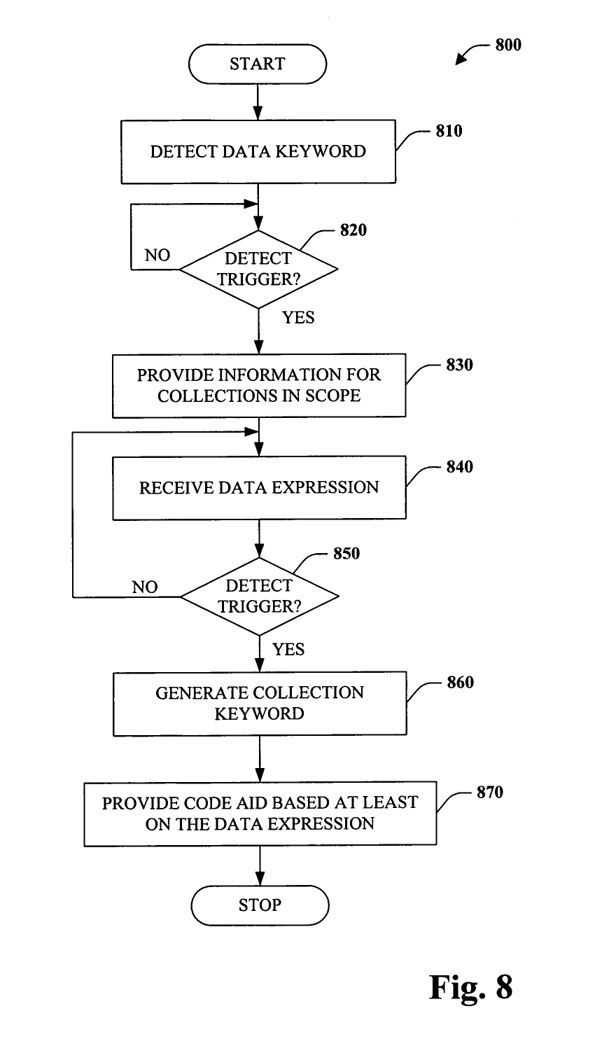

FIG. 8 depicts a method 800 that facilitates query specification in accordance with an aspect of the subject innovation. At reference numeral 810, a data keyword is detected. The data keyword is associated with a clause that specifies data to be retrieved. In one instance, the data keyword can correspond to “Select.” At 820 a determination is made as to whether a trigger as been detected. A trigger can include but is not limited to a space, comma, and new line. The method continues to loop until a trigger is detected. If a trigger is detected at 820, the method proceeds at 830, and provides assistance via information associated with all generic collections in scope. For instance, an iteration variable such as “C” followed by a dot as in “C.” can cause information associated with all collections to be presented to the user for selection when in fact “C” may be associated with only a “Customer” collection. At 840, a data expression is received that specifies particular data to be retrieved and/or computed. At 850, a determination is made as to whether a trigger is detected after the data expression. For example, the trigger can correspond to be is not limited to a new line (e.g., carriage return). If the trigger is not detected, the method reverts to 840 where the data expression is received. If the trigger is detected at 850, the method can proceed to 860 where a collection keyword is automatically generated. The collection keyword can correspond to, among other things, “From.” At reference numeral 870, programmatic aid is provided based at least on the data expression received in the previous data clause. According to one aspect of the innovation, the collections can be automatically specified base on the data expression where there is no ambiguity. For example, “Select Name” can be expanded to “Select Name From Customer.”

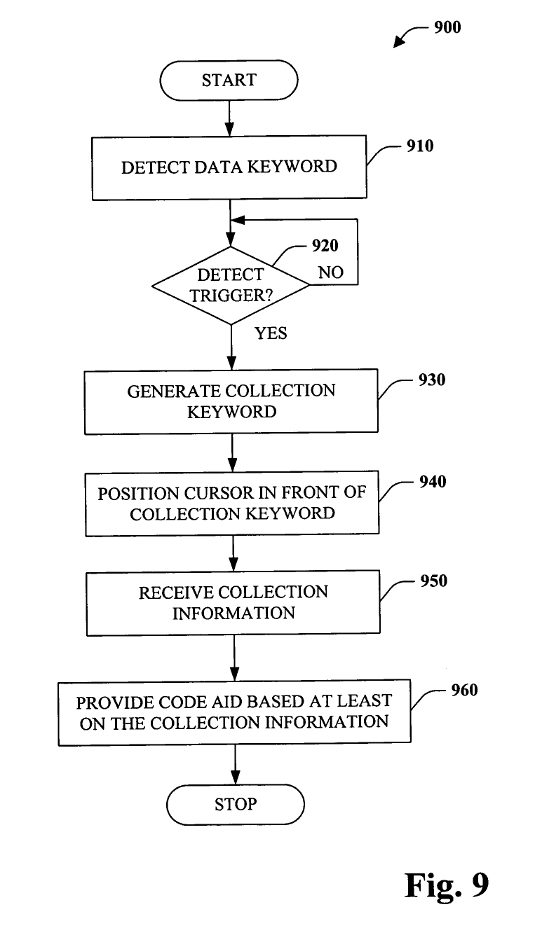

Turning to FIG. 9, a method 900 for aiding query coding is illustrated in accordance with an aspect of the subject innovation. At reference numeral 910, a data keyword is detected. Such keyword can correspond to “Select,” among other things. At 920, a determination is made as to whether a trigger is detected, for example a space. Method 900 can continue to loop until a trigger is detected. If a trigger is detected at 920, the method can continue at 930 where a collection keyword is generated. The collection keyword can correspond to “Where” in a SQL style query, for example. At reference numeral 940, a displayed cursor is positioned in front of the generated collection keyword. This changes the flow of query specification, suggesting that one or more collections be identified prior to the data to be retrieved from the one or more collections. At 950, collection information is received. At 950, code aid can be provided based on the collection information. After the collection information is received, the cursor can be moved to another query clause. For example, the cursor can be moved in front of the data keyword “Select” or the condition keyword “Where.” Movement can be accomplished manually by a user or automatically. In the later case, the movement can be directed based on an explicit user preference or setting. Alternatively, the movement can be directed based the learned preference of a user after observing their manual actions. Once the cursor is moved additional query data can be specified. This specification process will be improved with knowledge of the collection(s) over which other operations are specified. For example, a drop down menu can be populated with elements, properties, and the like associated with the specified collections alone or in a manner indicative of their relevance with respect to other data. In one particular instance, there can be two selectable tabs common and all, where the common tab is associated with collections associated with the “From” clause and the all tab with all generic collections.

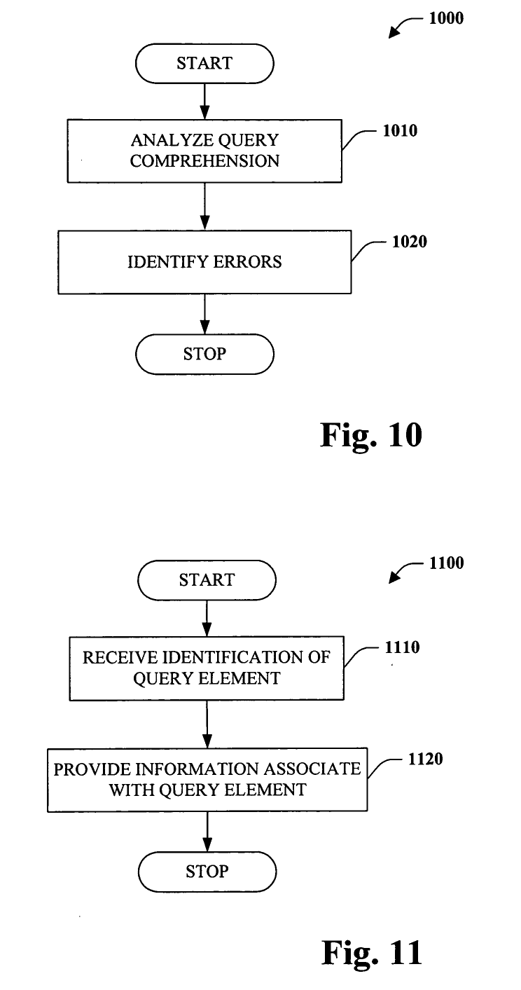

FIG. 10 is a flow chart diagram depicting a method 1000 of facilitating query coding via indication of errors or potential errors in a query statement. At 1010, a query or more specifically a query comprehension is analyzed. For example, the statement or portions thereof can be type checked. Such analyzing can be performed in one instance while a query comprehension is being specified, although the subject innovation is not so limited. At reference 1020, errors and/or potential errors are identified. Potential errors can be identified where there is a possibility that an element or group thereof is erroneous but there is not complete information at the time of the determination to identify such element(s) as an error. These errors and/or potential errors can be presented or identified to the user graphically by squiggly underlines of various colors, for example.

FIG. 11 illustrates a method 1100 to aid in query specification in accordance with an aspect of the subject disclosure. At reference numeral 1110, identification of a query element is received. Identification can be accomplished in one instance by, among other things, cursor rollover (e.g., hover) and/or depression of a keys predetermined in a predetermined sequence. At numeral 1120, information is provided regarding the identified query element. For example, the type of the query element can be provided via a pop-up text box, window or the like. By providing such information, a programmer is relieved for recalling all element information thereby facilitating query specification.

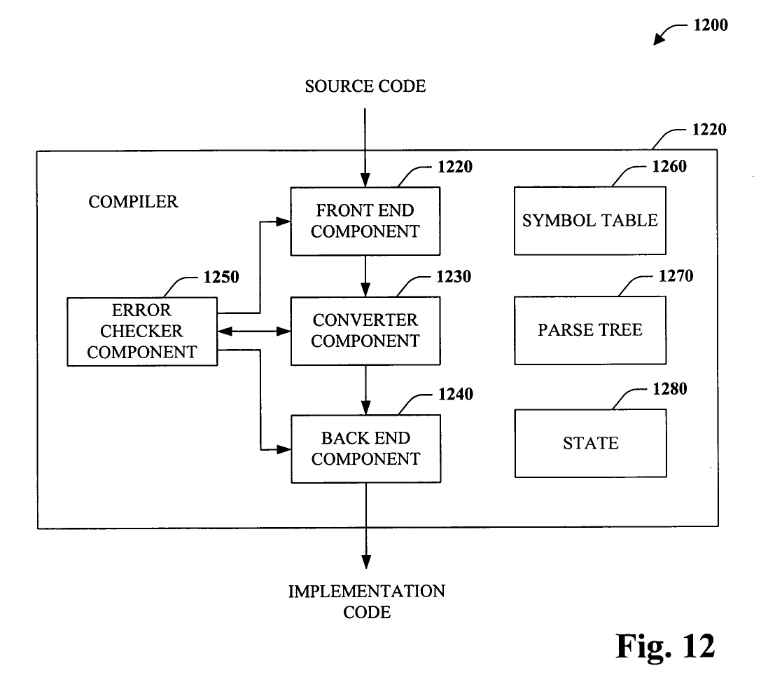

FIG. 12 is a block diagram depicting a compiler environment 1200 that can be utilized to generate implementation code (e.g., executable, intermediate language . . . ). However, aspects of the environment 1200 could also be employed as part of a background compiler, for instance related to a code editor, to enable intelligent or context sensitive programming assistance to be provided. The compiler environment 1200 includes a compiler 1220 including front-end component 1220, converter component 1230, back-end component 1240, error checker component 1250, symbol table 1260, parse tree 1270, and state 1280. The compiler 1220 accepts source code as input and produces implementation code as output. The input can include but is not limited to query expressions or elements capable of being identified by query expressions including but not limited to query comprehensions and abbreviations as described herein. The relationships amongst the components and modules of the compiler environment 1200 illustrate the main flow of data. Other components and relationships are not illustrated for the sake of clarity and simplicity. Depending on implementation, components can be added, omitted, split into multiple modules, combined with other modules, and/or other configurations of modules.

Compiler 1220 can accept as input a file having source code associated with processing of a sequence of elements. The source code may include query comprehensions and abbreviations, other expressions, associated functions, methods and/or other programmatic constructs. Compiler 1220 may process source code in conjunction with one or more components for analyzing constructs and generating or injecting code.

A front-end component 1220 reads and performs lexical analysis upon the source code. In essence, the front-end component 1220 reads and translates a sequence of characters (e.g., alphanumeric) in the source code into syntactic elements or tokens, indicating constants, identifiers, operator symbols, keywords, and punctuation among other things.

Converter component 1230 parses the tokens into an intermediate representation. For instance, the converter component 1230 can check syntax and group tokens into expressions or other syntactic structures, which in turn coalesce into statement trees. Conceptually, these trees form a parse tree 1270. Furthermore and as appropriate, the converter module 1230 can place entries into a symbol table 1230 that lists symbol names and type information used in the source code along with related characteristics.

A state 1280 can be employed to track the progress of the compiler 1220 in processing the received or retrieved source code and forming the parse tree 1270. For example, different state values indicate that the compiler 1220 is at the start of a class definition or functions, has just declared a class member, or has completed an expression. As the compiler progresses, it continually updates the state 1280. The compiler 1220 may partially or fully expose the state 1280 to an outside entity, which can then provide input to the compiler 1220.

Based upon constructs or other signals in the source code (or if the opportunity is otherwise recognized), the converter component 1230 or another component can inject code to facilitate efficient and proper execution. For example, code can be injected to expand a comprehension abbreviation or translate from a query comprehension to sequence operators. Rules coded into the converter component 1230 or other component indicates what must be done to implement the desired functionality and identify locations where the code is to be injected or where other operations are to be carried out. Injected code typically includes added statements, metadata, or other elements at one or more locations, but this term can also include changing, deleting, or otherwise modifying existing source code. Injected code can be stored as one or more templates or in some other form. In addition, it should be appreciated that symbol table manipulations and parse tree transformations can take place.

Based on the symbol table 1260 and the parse tree 1270, a back-end component 1240 can translate the intermediate representation into output code. The back-end component 1240 converts the intermediate representation into instructions executable in or by a target processor, into memory allocations for variables, and so forth. The output code can be executable by a real processor, but the invention also contemplates output code that is executable by a virtual processor.

Furthermore, the front-end component 1220 and the back end component 1240 can perform additional functions, such as code optimization, and can perform the described operations as a single phase or in multiple phases. Various other aspects of the components of compiler 1220 are conventional in nature and can be substituted with components performing equivalent functions. Additionally, at various stages during processing of the source code, an error checker component 1250 can check for errors such as errors in lexical structure, syntax errors, and even semantic errors. Upon detection error, checker component 1250 can halt compilation and generate a message indicative of the error.

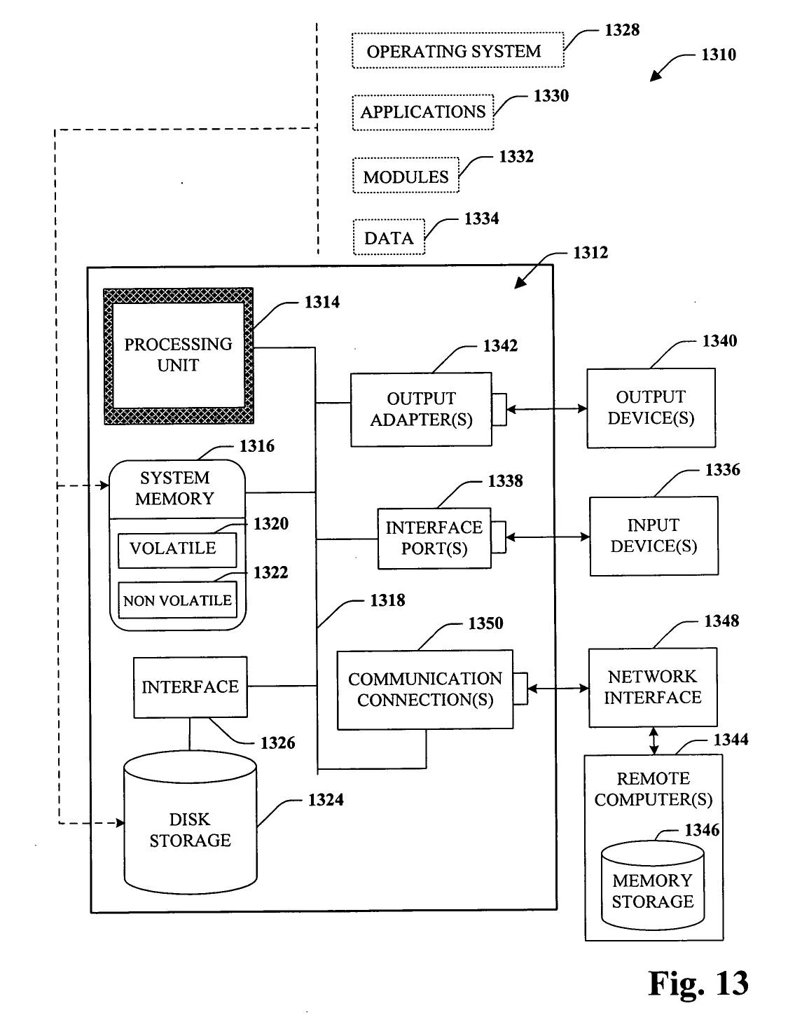

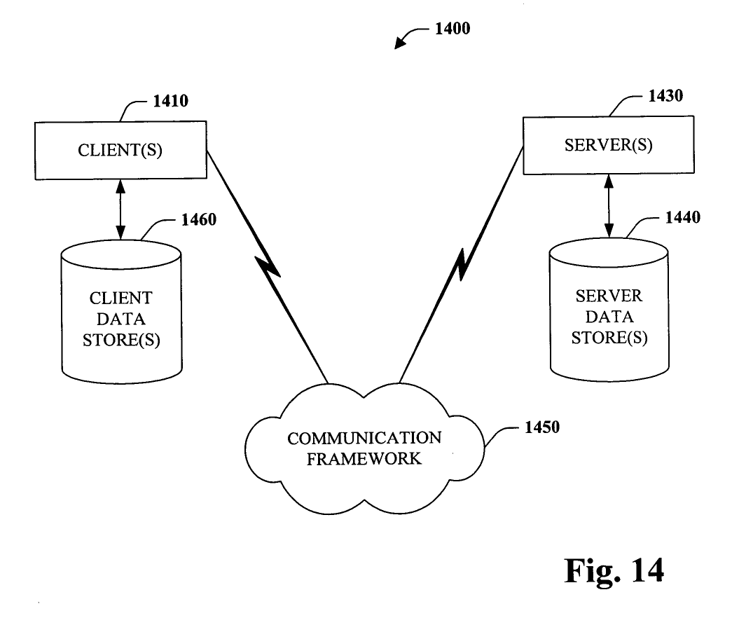

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316, and a system bus 1318. The system bus 1318 couples system components including, but not limited to, the system memory 1316 to the processing unit 1314. The processing unit 1314 can be any of various available microprocessors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/non-removable, volatile/non-volatile computer storage media. FIG. 13 illustrates, for example, disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the present invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312 and to output information from computer 1312 to an output device 1340. Output adapter 1342 is provided to illustrate that there are some output devices 1340 like displays (e.g., flat panel and CRT), speakers, and printers, among other output devices 1340 that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems, power modems and DSL modems, ISDN adapters, and Ethernet cards or components.

FIG. 14 is a schematic block diagram of a sample-computing environment 1400 with which the present invention can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the present invention, for example. One possible communication between a client 1410 and a server 1430 may be in the form of a data packet adapted to be transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. A computer-implemented system to facilitate programming comprising the following computer executable components:
a keyword component that detects a query statement keyword from a query comprehension; and
an assistance component that provides programmatic assistance with respect to an identified query statement.

2. The system of claim 1, the assistance component comprises a discovery component that ascertains type information of collections in scope.

3. The system of claim 2, the assistance component comprises a display component that displays properties, methods, and/or functions of types of the collections.

4. The system of claim 3, further comprising a generation component that generates a collection keyword in response to detection of a data keyword.

5. The system of claim 4, further comprising a cursor control component that positions a displayed cursor in front of the collection identifier to facilitate receipt of the identity of one or more collections to be queried.

6. The system of claim 5, the cursor control component positions the cursor in front of the data identifier upon receipt of one or more collection identities to facilitate identification of categories of data to be selected.

7. The system of claim 5, the keyword generation component generates a condition keyword.

8. The system of claim 7, the display component further comprises an intelligence component that learns user preferences and interacts with the cursor component to determine where to position the cursor after collections are identified.

9. The system of claim 1, the assistance component includes an error component that identifies errors in query comprehension specification.

10. The system of claim 1, the assistance component includes a tip component that provides type information for elements of a query comprehension upon rollover of a cursor or upon depression of a predetermined combination of keys.

11. A computer-implemented method to facilitate program specification comprising the following computer executable acts:
identifing a query comprehension keyword;
detecting a trigger that follows the keyword; and
displaying information about one or more collections in scope upon trigger detection.

12. The method of claim 11, detecting a trigger comprises identifying one of a dot, a comma, a space, and a new line.

13. The method of claim 11, identifying a keyword comprises discovering one of “Select,” “From,” “Where,” “Having,” and “Group By.”

14. The method of claim 11, further comprising automatically generating one or more query comprehension keywords.

15. The method of claim 11, further comprising capturing entered query comprehension elements to limit the collections in scope.

16. The method of claim 11, further comprising automatically generating and completing a query clause based on context.

17. The method of claim 11, further comprising:
detecting an aggregate keyword that follows the query comprehension keyword;
detecting a trigger that follows the aggregate keyword; and
displaying information upon trigger detection to facilitate completion of an aggregate statement embedded within a query clause.

18. The method of claim 11, further comprising providing information about types within a query clause.

19. A computer-implemented method to facilitate query specification comprising the following computer executable acts:
identifying a data keyword;
generating a collection keyword upon data keyword identification;
positioning a displayed cursor after the collection keyword;
receiving identification of one or more data collections to be queried, following the collection keyword; and
providing coding assistance based on the identity of the one or more collections.

20. The method of claim 19, further comprising repositioning the cursor after either the data identifier keyword or another query keyword based on a determined user preference after identification of the one or more data collections.
